(19) United States
(12) Patent Application Publication
(10) Pub. No.: US 2025/0376613 A1
(43) Pub. Date: Dec. 11, 2025

(54) WETTING AGENT COMPOSITIONS, AND RELATED METHODS AND DRILLING FLUIDS INCLUDING THE WETTING AGENT COMPOSITIONS

(71) Applicant: Schlumberger Technology Corporation, Sugar Land, TX (US)

(72) Inventors: Dimitri Khramov, Katy, TX (US); Chao Yu Sie, Katy, TX (US); Christopher Daeffler, Sugar Land, TX (US)

(21) Appl. No.: 18/734,685

(22) Filed: Jun. 5, 2024

(51) Int. Cl. C09K 8/34

(52) U.S. Cl. CPC C09K 8/34

(57) ABSTRACT

A wetting agent composition for drilling a borehole includes a wetting agent including unsaturated fatty acids and at least some saturated fatty acids, and a wax inhibitor formulated and configured to inhibit the formation of wax crystals that agglomerate and gel in the wetting agent composition, wherein the wetting agent composition exhibits a pour point lower than about 0° C. Related methods of forming a borehole and related drilling fluids are also disclosed.

### CROSS REFERENCE TO RELATED APPLICATIONS

N/A.

### BACKGROUND

Wellbore drilling operations include drilling a borehole in a formation to access reservoirs of hydrocarbons and other subsurface resources. During drilling of the borehole, various fluids may be circulated into the borehole through a drill pipe and drill bit, and may subsequently flow upward through the borehole to the surface. For example, a drilling fluid (e.g., an aqueous-based fluid or an oil-based fluid) may be pumped down the inside of the drill pipe, through the drill bit, and into the borehole or wellbore. The drilling fluid returns to the surface through the annulus. The drilling fluid may lubricate and cool the drill bit, facilitate transport of formation cuttings to the surface, prevent formation of blowouts by maintaining a hydrostatic pressure greater on the formation than the formation pressure, maintain well stability, and reduce fluid loss to the formation.

Drilling fluids may be water-based (aqueous-based), or may be non-aqueous, such as oil-based or synthetic-based. In non-aqueous drilling fluids, water is the discontinuous (dispersed) phase and oil (or a synthetic material) is the continuous phase. Non-aqueous drilling fluids may be more compatible with water-sensitive formations, such as water-sensitive clays, than aqueous drilling fluids. In addition, non-aqueous drilling fluids may not substantially cause shale instability to the formation as may be more common with aqueous drilling fluids.

Non-aqueous drilling fluids may be stabilized with a wetting agent formulated and configured to provide an oil-wet surface to drilling solids and particles in the drilling fluid to reduce or prevent agglomeration and the particles from settling in the drilling fluid. One problem associated with wetting agents is the delivery of the wetting agents into the drilling fluid. For example, many wetting agents have a high melting temperature and are solids at ambient conditions proximate a borehole, making it difficult to mix the wetting agents into the drilling fluid. Wetting agents are conventionally provided to a drilling fluid as a composition that includes a solvent such as a base oil, and a pour point depressant to facilitate flow of the wetting agent to the drilling fluid.

### BRIEF SUMMARY

In some embodiments, a wetting agent composition includes a wetting agent including unsaturated fatty acids and at least some saturated fatty acids, and a wax inhibitor formulated and configured to inhibit the formation of wax crystals that agglomerate and gel in the wetting agent composition, wherein the wetting agent composition exhibits a pour point lower than about 0° C.

In some embodiments, a method of forming a borehole extending through an earth formation includes mixing a wetting agent composition with a drilling fluid, and forming a borehole in the earth formation while pumping the drilling fluid including the wetting agent composition into the earth formation. The wetting agent composition includes a wetting agent including unsaturated fatty acids and at least some saturated fatty acids, and a wax inhibitor.

In some embodiments, a drilling fluid includes an oleaginous base fluid, a wetting agent composition, and an emulsifier. The wetting agent composition includes a wetting agent including greater than about 2.0 weight percent saturated fatty acids sourced from vegetable oils or animal sources, and a wax inhibitor.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 is a representation of a drilling system for drilling an earth formation to form a wellbore, according to at least one embodiment of the present disclosure; and

FIG. 2A through FIG. 2F are chemical structures of different wax inhibitors that may be used in a wetting agent composition, according to embodiments of the disclosure;

FIG. 3 is a simplified flow diagram illustrating a method of drilling a borehole, according to at least one embodiment of the disclosure;

FIG. 4 is a simplified flow diagram illustrating a method of dewaxing a mixture of fatty acids including at least some saturated fatty acids;

FIG. 5A and FIG. 5B are graphs comparing R600 and the R6 Fann shear stress, respectively, of drilling fluids having different wetting agents;

FIG. 5C is a graph illustrating the 10-minute gel strength of the drilling fluids; and

FIG. 5D is a graph illustrating the fluid loss exhibited by the drilling fluids.

### DETAILED DESCRIPTION

This disclosure generally relates to devices, systems, and methods of manufacturing and using drilling fluid additives for downhole applications, such wetting agent compositions for use in a drilling fluid. The wetting agent composition may be used in a drilling fluid, such as drill-in fluids (also referred to as “reservoir drill-in fluids” (RDF)). The wetting agent composition may also be used in other wellbore fluids, such as workover fluids, spacer fluids (e.g., a fluid introduced into the wellbore after a drilling fluid and prior to a cement composition to flush residual drilling fluid from the annulus), stimulation fluids, or other wellbore fluids. The wetting agent composition may be used during drilling of a wellbore or borehole for producing hydrocarbons, for storing hydrocarbons, or for forming other types of wellbores. The wetting agent composition is not limited to the particular type of borehole or wellbore being drilled.

The wetting agent composition may be provided as a component of a drilling fluid. In some embodiments, the wetting agent composition is used in an oil-based or synthetic-based wellbore fluid (e.g., an oil-based drilling fluid or a synthetic-based drilling fluid, which may also be referred to as a non-aqueous drilling fluid or an invert emulsion drilling fluid).

The wetting agent composition may include one or more wetting agents and one or more wax inhibitors. The wetting agent may include a mixture of unsaturated fatty acids and saturated fatty acids and may be formulated and configured to provide an oil-wet surface to solids in the drilling fluid and to cuttings in the drilling fluid. The wetting agent may synergistically, with an emulsifier, improve stability of an emulsion of the drilling fluid and reduce fluid losses to the earth formation. As described herein, the wetting agent may derived, at least partially from, vegetable oils and may include a mixture of unsaturated fatty acids and saturated fatty acids which are present in the vegetable oils. In some embodiments, the saturated fatty acids may include linear saturated fatty acids that are naturally occurring (e.g., present in vegetable oils and/or present in animal fats) and may be linear saturated fatty acids. In some embodiments, the wetting agent includes greater than about 2.0 weight percent saturated fatty acids (such as greater than about 3.0 weight percent, or greater than about 5.0 weight percent of saturated fatty acids). The wax inhibitor may be formulated and configured to reduce and/or prevent the formation of solid wax in the wetting agent composition. In some embodiments, the wax inhibitor reduces the pour point of the wetting agent composition such that the wetting agent composition may be poured or mixed into the drilling fluid at the well site, such as by pouring the wetting agent composition from a barrel into a mud pit including the drilling fluid. The pour point of the wetting agent composition may be less than about 0° C., such as less than about −10° C., or less than about −25° C.

The wax inhibitor in the wetting agent composition may facilitate the use of wetting agent mixtures including saturated fatty acids without forming solid waxes that agglomerate and prevent pouring of the wetting agent composition from, for example, a drum or barrel into the drilling fluid (e.g., into a mud pit). Rather, waxes that form in the presence of the wax inhibitor may not agglomerate and form gels in the wetting agent composition, allowing the wetting agent composition to remain flowable at temperatures less than about 0° C., as described above. In addition, the wetting agent composition may not include solvents and/or pour point depressants, such as glycol-based pour point depressants. Accordingly, the wetting agent composition may include a higher amount of active components (the wetting agent) since the wetting agent composition does not include solvents or glycol-based pour point depressants. In some embodiments, the wetting agent composition comprises, consists essentially of, or consists of the wetting agent and the wax inhibitor. In other embodiments, the wetting agent composition includes the wetting agent, the wax inhibitor, and a base oil to further reduce the pour point of the wetting agent composition.

Due to the high pour point of saturated fatty acids, saturated fatty acids have not been used as wetting agents. Since the wetting agent composition may include some saturated fatty acids, the wetting agent may be derived from sources that include some saturated acids, increasing the availability and decreasing the costs associated with forming the wetting agent. For example, the wetting agent may be derived from vegetable oils and/or animal fats that include a mixture of unsaturated fatty acids and saturated fatty acids (or a mixture of unsaturated fatty acid esters and saturated fatty acid esters). Accordingly, the wetting agent may be derived (e.g., sourced) from vegetable oils, such as canola oil, safflower oil, flaxseed oil, sunflower oil, corn oil, soybean oil, peanut oil, cottonseed oil, algae oil, palm oil, other vegetable oils, or oils sourced from animals.

In some embodiments, the wax inhibitor constitutes less than about 1.0 weight percent of the wetting agent composition. Accordingly, the wax inhibitor may not affect or substantially affect the properties of the drilling fluid including the wax inhibitor, but may provide substantial benefits in terms of reducing the pour point of the wetting agent composition. The wetting agent composition may be poured and mixed into the drilling fluid at conditions encountered at the well site, such as at temperatures as low as −25° C.

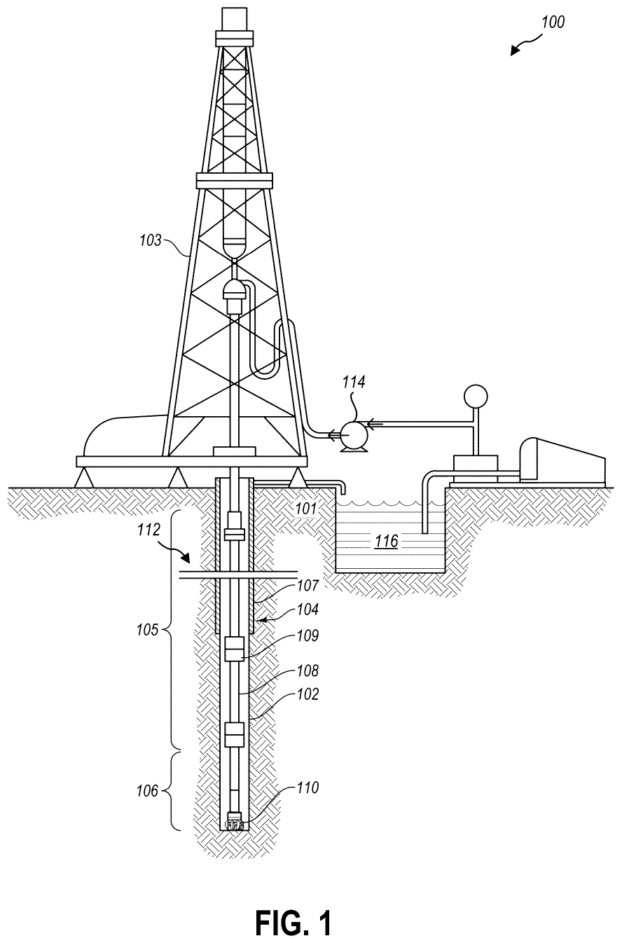

FIG. 1 shows one example of a drilling system 100 for drilling an earth formation 101 to form a borehole 102 defining a wellbore 112. The drilling system 100 includes a drill rig 103 used to turn a drilling tool assembly 104 which extends downward into the borehole 102 and/or wellbore 112. The drilling tool assembly 104 may include a drill string 105, a bottomhole assembly (“BHA”) 106, and a bit 110, attached to the downhole end of drill string 105. The wellbore 112 may be used to facilitate one or more of hydrocarbon recovery from the earth formation 101, carbon storage in the earth formation 101 (such as by injection of carbon dioxide into the earth formation 101 injection of other fluids into the earth formation 101, stimulation of geological formations for hydrogen generation and/or carbon dioxide storage, or other processes.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the borehole 102 or wellbore 112 as it is being drilled.

The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore 112. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 112. The bit 110 may also be a junk mill used to mill away tools, plugs, cement, other materials within the borehole 102, or combinations thereof. Swarf or other cuttings formed by use of a mill may be lifted to surface, or may be allowed to fall downhole.

During drilling operations, a wellbore fluid (e.g., a drilling fluid) may be used to facilitate lubrication and cooling of the bit 110 and removal of cuttings of the earth formation 101. The drilling fluid may be configured to be circulated through the drill string 105, out of the drill string 105 through the bit 110, and into the annulus between the drill string 105 and the surfaces of the earth formation 101 defining the borehole 102 (or the wellbore 112). For example, a surface pump 114 may pump the drilling fluid from a mud pit 116 which holds the drilling fluid. In some embodiments, one or more additives may be added to the drilling fluid, such as by providing the one or more additives to the mud pit 116.

The drilling fluid may be used to facilitate lubrication and cooling of the bit 110 and removal of cuttings of the earth formation 101 from the borehole 102 and/or wellbore 112. The drilling fluid may include one or more materials formulated and configured to facilitate drilling of the earth formation 101. The drilling fluid may include a wetting agent composition including a wetting agent formulated and configured to cause surfaces of particles in the drilling fluid to be oil wet. In addition, the wetting agent composition may further include a wax inhibitor formulated and configured to reduce the tendency of wax crystals (of the wetting agent) to form and/or interlock and form a three-dimensional network in the wetting agent composition. The wax inhibitor may reduce the pour point of the wetting agent, facilitating mixing of the wetting agent composition in the drilling fluid at the well site at ambient conditions encountered at the well site (e.g., temperature as low as about −25° C.). In some embodiments, the wetting agent composition is free of (e.g., substantially free of) solvents, such as base oils (e.g., diesel, a mixture of alkanes with a carbon chain length ranging from C₁₀ to C₂₀ (e.g., Saraline 185V, commercially available from Shell PLC of London, England), a mixture of C₁₆ to C₁₈ internal olefins), and/or pour point depressants (other than the wax inhibitor). For example, the wetting agent composition may be free of diesel and glycol-based pour point depressants. In other embodiments, the wetting agent composition includes the wetting agent, the wax inhibitor, and a base oil formulated and configured to further reduce the pour point of the wetting agent composition.

The drilling fluid may include a base fluid, the wetting agent composition, and optionally, one or more additives (e.g., one or more emulsifiers, surfactants, bridging materials, viscosifiers, thinners (e.g., dispersion aids), weighting materials, filtration control agents, shale stabilizers, pH buffers, scavengers, emulsifiers, emulsion activators, corrosion inhibitors, oxygen scavengers, gelling agents, scale inhibitors, foaming agents, defoamers, scale inhibitors, solvents, rheological additives, or other additives).

In some embodiments, the drilling fluid is a non-aqueous-based drilling fluid (e.g., an oil-based drilling fluid, a synthetic-based drilling fluid) and may be referred to as a “non-aqueous fluid” (NAF), an “invert drilling fluid,” an “invert emulsion drilling fluid,” or a “drilling mud.” The drilling fluid may include an invert emulsion wherein the continuous external phase is oleaginous, and the internal discontinuous phase is aqueous.

In embodiments where the drilling fluid includes a non-aqueous-based drilling fluid, such as an oil-based drilling fluid or a synthetic-based drilling fluid, the base fluid may include an oleaginous or oil-based fluid, such as a natural or synthetic oil. In some embodiments the oleaginous fluid is selected from the group consisting of at least one of diesel oil, mineral oil, a synthetic oil, (e.g., hydrogenated and unhydrogenated olefins including polyalpha olefins, linear and branched olefins), a mixture of alkanes with a carbon chain length ranging from C₁₀ to C₂₀ (e.g., Saraline 185V, commercially available from Shell PLC of London, England), polydiorganosiloxanes, siloxanes, organosiloxanes, or esters of fatty acids (e.g., straight chained, branched and cyclical alkyl ethers of fatty acids). In some embodiments, the base fluid includes a mixture of C₁₆ to C₁₈ internal olefins (an alkene in which the double bond is within the carbon chain rather than at a terminal portion (at the alpha position) of the carbon chain).

An internal phase of an emulsion of the oleaginous or oil-based fluid may include one or more salts. The one or more salts may provide a desired density to the drilling fluid and may also reduce the effect of the drilling fluid on hydratable clays and shales the earth formation 101. The salts may include salts of one or more of sodium, calcium, aluminum, magnesium, zinc, potassium, strontium, or lithium, and salts of one or more of chlorides, bromides, carbonates, iodides, chlorates, bromates, formates, nitrates, oxides, phosphates, sulfates, silicates, or fluorides. In some embodiments, the salt includes a divalent halide, such as an alkaline earth halide (e.g., calcium chloride (CaCl₂), calcium bromide (CaBr₂)), or a zinc halide. The salt may include cesium formate (HCOOR), sodium bromide (NaBr), potassium bromide (KBr), and cesium bromide (CsBr). The particular composition of the salt may be selected based on compatibility with the earth formation 101 and/or to match the brine phase of a completion fluid and/or a non-aqueous fluid. In some embodiments, the salt includes calcium chloride.

The salt may constitute from about 5.0 weight percent to about 30.0 weight percent of the drilling fluid, such as from about 5.0 weight percent to about 10.0 weight percent, from about 10.0 to about 20.0 weight percent, or from about 20.0 weight percent to about 30.0 weight percent of the drilling fluid. However, the disclosure is not so limited, and the weight percent of the salt and the water in the drilling fluid may be different than that described.

As described above, the drilling fluid may include the wetting agent composition including the wetting agent and the wax inhibitor. The wetting agent may be formulated and configured to provide an oil wet surface to drilling solids and to one or more solids present in the drilling fluid, such as barite. The wetting agent may also be referred to herein as an “oil-wetting agent.” Providing oil-wet surfaces to particles in the drilling fluid may increase the stability of the drilling fluid, such as by reducing (e.g., preventing) agglomeration of solid particles and/or setting (e.g., falling out) of solid particles in the drilling fluid. For example, contacting the particles with the wetting agent may reduce the contact angle between the base fluid of the drilling fluid and solids in the drilling fluid, promoting greater contact between the drilling fluid and surfaces of the solids.

The wetting agent may include one or more fatty acids. In some embodiments, the wetting agent includes a mixture of fatty acids, such as a mixture of unsaturated fatty acids and saturated fatty acids. The wetting agent may comprise, consist essentially of, or consist of a mixture of fatty acids including one or more unsaturated fatty acids and one or more unsaturated fatty acids. In some embodiments, the wetting agent includes at least one unsaturated fatty acid and at least one saturated fatty acid. The mixture of fatty acids may be sourced from one or more vegetable oils. As described herein, the wax inhibitor may inhibit the formation of large wax crystals from the saturated fatty acids that are present in the wetting agent and may prevent the agglomeration of smaller wax crystals in the wetting agent composition. The wax inhibitor may reduce the pour point of the wetting agent composition including the wetting agent and the wax inhibitor.

In some embodiments, the wetting agent includes fatty acids that are sourced from vegetable oils and/or from animals and may include one or more unsaturated fatty acids and one or more saturated fatty acids. The wetting agent may include fatty acids that are not sourced from tall oil (an oil produced by conifer trees). Thus, the wetting agent may be substantially free of tall oil fatty acids (TOFAs), sourced from tall oil. In some embodiments, the wetting agent includes C₁₈ fatty acids, such as oleic acid, linoleic acid, and α-linolenic acid, but not from tall oil. Vegetable oils that include saturated fatty acids are not conventionally used in the production of wetting agents because the saturated fatty acids crystalize in a structuring effect wherein the crystals exhibit long range interactions and form a solid network or large networks of crystals that prevents the flow of the wetting agent.

In some embodiments, the one or more fatty acids of the wetting agent are sourced from one or more vegetable oils, such as one or more of canola oil, safflower oil, flaxseed oil, sunflower oil, corn oil, soybean oil, cottonseed oil, peanut oil, olive oil, rapeseed oil, almond oil, grape seed oil, linseed oil, oiticica oil, poppyseed oil, sesame oil, tung oil, walnut oil, algae oil, palm oil, and wheat germ oil. In some embodiments, the one or more fatty acids are sourced from canola oil. In some embodiments, the one or more fatty acids are sourced from safflower oil, flaxseed oil, sunflower oil, or corn oil. By way of non-limiting example, the vegetable oils may include glycerides (e.g., triglycerides), which may be hydrolyzed to form fatty acids that make up the glycerides, and one or more alcohols (e.g., glycerol). In addition, the one or more fatty acids of the wetting agent may be sourced from animals. In some embodiments, the one or more fatty acids includes a mixture of one or more fatty acids derived from one or more vegetable sources, and one or more fatty acids derived from one or more animal sources. In some embodiments, the one or more fatty acids are sourced from animals are derived from tallow (e.g., solid animal fat (e.g., suet) from beef, lamb, mutton, and/or another animal).

As described above, the wetting agent may include one or more unsaturated fatty acids and one or more saturated fatty acids. The unsaturated fatty acids and the saturated fatty acids may be naturally occurring (e.g., derived from plants, such as from vegetable oils; and/or derived from animal sources). The fatty acids may be linear, branched, or may include one or more cyclic groups. The unsaturated fatty acids may include a monounsaturated fatty acid having one carbon to carbon double bond; a di-unsaturated fatty acid having two carbon to carbon double bonds; a tri-unsaturated fatty acid having three carbon to carbon double bonds; a tetra-unsaturated fatty acid having four carbon to carbon double bonds; a penta-unsaturated fatty acid having five carbon to carbon double bonds; a hexa-unsaturated fatty acid having six carbon to carbon double bonds; or a polyunsaturated fatty acid having more than six carbon to carbon double bonds. In some embodiments, the wetting agent includes one or more monounsaturated fatty acids, one or more di-unsaturated fatty acids, and one or more tri-unsaturated fatty acids.

The unsaturated fatty acid may include one or more of linolenic acid (e.g., α-linolenic acid and/or γ-linolenic acid), stearidonic acid, eicosapentaenoic acid, cervonic acid, linoleic acid, linolelaidic acid, arachidonic acid, docosatetranoic acid, palmitoleic acid, vaccenic acid, paullinic acid, oleic acid, elaidic acid, erucic acid, crotonic acid, myristoleic acid, sapienic acid, gadoleic acid, or eicosenoic acid.

The saturated fatty acids may include one or more of valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, behenic acid, tricosylic acid, lignoceric acid, pentacosylic acid, cerotic acid, carboceric acid, montanic acid, nonacosylic acid, meliisic acid, lacceroic acid, or psyllic acid. In some embodiments, the saturated fatty acids include C₁₆ and/or C₁₈ saturated fatty acids. For example, the saturated fatty acids may include one or both of palmitic acid and stearic acid. In some embodiments, the saturated fatty acids include C₁₂ fatty acids, such as lauric acid. In some embodiments, the saturated fatty acids include linear saturated fatty acids and may be naturally occurring, such as saturated fatty acids sourced from plants (e.g., vegetable oils) and/or animals.

In some embodiments, the unsaturated fatty acid includes one or more unsaturated C₁₈ fatty acids, such as one or more of oleic acid, linoleic acid, linolelaidic acid, α-linolenic acid, γ-linolenic acid, or stearidonic acid. In some embodiments, the wetting agent includes unsaturated fatty acids including each of oleic acid, linoleic acid, and α-linolenic acid; and saturated fatty acids including one or both of stearic acid and palmitic acid. In some embodiments, the unsaturated fatty acid may include one or more unsaturated fatty acids with a relatively higher melting temperature than a predetermined temperature (e.g., a desired pour point of the wetting agent composition). By way of non-limiting example, the unsaturated fatty acid may include elaidic acid. As described herein, the wax inhibitor may reduce and/or prevent the formation of wax crystals that cause agglomeration and an increase in the pour point of the wetting agent composition including such unsaturated fatty acids.

The types of unsaturated acids and saturated acids, as well as the relative amounts of the unsaturated acids and the saturated fatty acids, may depend at least in part, on the vegetable oils from which the fatty acids are derived. In some embodiments, the saturated fatty acids include one or more C₁₈ saturated fatty acids and one or more C₁₆ saturated fatty acids. The saturated fatty acids may further include one or more C₁₂ saturated fatty acids. In some embodiments, the wetting agent comprises, consists essentially of, or consists of a mixture of oleic acid, linoleic acid, α-linolenic acid, palmitic acid, and stearic acid. In some embodiments, depending on the vegetable oil(s) from which the fatty acids are derived, the wetting agent may further include abietic acid (which may be present in the form of rosin).

In some embodiments, a weight ratio of monounsaturated fatty acids (e.g., oleic acid) to polyunsaturated (e.g., one or more of linoleic acid, linolenic acid) fatty acids in the wetting agent is within a range of from about 1.0:0.1 to about 1.0:5.0 by weight, such as from about 1.0:0.1 to about 1.0:0.2, from about 1.0:0.2 to about 1.0:0.5, from about 1.0:0.5 to about 1.0:1.0, from about 1.0:1.0 to about 1.0:2.0, from about 1.0:2.0 to about 1.0:3.0, from about 1.0:3.0 to about 1.0:5.0 by weight. In some embodiments, the wetting agent includes a higher weight percent of monounsaturated fatty acids than a weight percent of polyunsaturated fatty acids. In other embodiments, the wetting agent includes a higher weight percent of polyunsaturated fatty acids than of monounsaturated fatty acids.

A weight percent of unsaturated fatty acids in the wetting agent may be within a range of from about 70.0 weight percent to about 99.0 weight percent, such as from about 70.0 weight percent to about 75.0 weight percent, from about 75.0 weight percent to about 80.0 weight percent, from about 80.0 weight percent to about 85.0 weight percent, from about 85.0 weight percent to about 90.0 weight percent, from about 90.0 weight percent to about 95.0 weight percent, or from about 95.0 weight percent to about 99.0 weight percent. In some embodiments, unsaturated fatty acids constitute less than about 95.0 weight percent, such as less than about 90.0 weight percent, less than about 85.0 weight percent, or less than about 80.0 weight percent of the fatty acids in the wetting agent.

A weight percent of monounsaturated fatty acids in the wetting agent may be within a range of from about 10.0 weight percent to about 80.0 weight percent, such as from about 10.0 weight percent to about 20.0 weight percent, from about 20.0 weight percent to about 40.0 weight percent, from about 40.0 weight percent to about 60.0 weight percent, or from about 60.0 weight percent to about 80.0 weight percent. In some embodiments, monounsaturated fatty acids constitute greater than about 40.0 weight percent, such as greater than about 50.0 weight percent, greater than about 60.0 weight percent, or greater than about 70.0 weight percent of the fatty acids in the wetting agent.

A weight percent of polyunsaturated fatty acids in the wetting agent may be within a range of from about 10.0 weight percent to about 80.0 weight percent, such as from about 10.0 weight percent to about 20.0 weight percent, from about 20.0 weight percent to about 30.0 weight percent, from about 30.0 weight percent to about 40.0 weight percent, from about 40.0 weight percent to about 60.0 weight percent, or from about 60.0 weight percent to about 80.0 weight percent of the fatty acids in the wetting agent.

A weight percent of saturated fatty acids in the wetting agent may be within a range of from about 1.0 weight percent to about 30.0 weight percent, such as from about 1.0 weight percent to about 2.0 weight percent, from about 2.0 weight percent to about 3.0 weight percent, from about 3.0 weight percent to about 5.0 weight percent, from about 5.0 weight percent to about 10.0 weight percent, from about 10.0 weight percent to about 15.0 weight percent, from about 15.0 weight percent to about 20.0 weight percent, or from about 20.0 weight percent to about 30.0 weight percent. In some embodiments, saturated fatty acids may constitute greater than about 1.0 weight percent, such as greater than about 2.0 weight percent, greater than about 3.0 weight percent, greater than about 5.0 weight percent, greater than about 10.0 weight percent, greater than about 15.0 weight percent, greater than about 20.0 weight percent, or greater than about 25.0 weight percent of the fatty acids in the wetting agent. In some embodiments, the saturated fatty acids are linear saturated fatty acids.

The wetting agent and/or the wetting agent composition may have an iodine value (IV; also referred to as the “iodine absorption value” or the “iodine number”) greater than about 100, such as greater than about 110, greater than about 120, greater than about 130, greater than about 140, greater than about 150, or greater than about 160. The iodine value may include the mass in grams of iodine that is consumed by 100 grams of the wetting agent. The iodine value may quantify the degree of unsaturation of the wetting agent since the iodine may react with the unsaturated bonds (e.g., the double bonds) of the unsaturated fatty acids. Accordingly, the higher the iodine value, the higher the degree of unsaturation in the wetting agent.

The wetting agent may constitute from about 90.0 weight percent to about 99.9 weight percent of the wetting agent composition, such as from about 90.0 weight percent to about 95.0 weight percent, from about 95.0 weight percent to about 98.0 weight percent, from about 98.0 weight percent to about 99.0 weight percent, from about 99.0 weight percent to about 99.5 weight percent, or from about 99.5 weight percent to about 99.9 weight percent of the wetting agent composition. The wetting agent may constitute greater than about 95.0 weight percent of the wetting agent composition, such as greater than about 98.0 weight percent, greater than about 98.5 weight percent, greater than about 99.0 weight percent, or greater than about 99.5 weight percent of the wetting agent composition. As described herein, the presence of the wax inhibitor in the wetting agent composition facilitates the use of a higher weight percent of the wetting agent (e.g., a higher percent of actives present) in the wetting agent composition compared to conventional wetting agent compositions which include solvents and pour point depressants to facilitate flowability of the wetting agent at a well site to mix the wetting agent with a drilling fluid.

During formation of the wetting agent, the wetting agent may be heated to above a melting temperature of the components (e.g., the fatty acids) thereof. Responsive to cooling, at least some components of the wetting agent may precipitate and form a wax including wax crystals. In some embodiments, the wax crystals include wax crystals formed from fatty acids having a relatively higher melting temperature, such as of saturated fatty acids and/or unsaturated fatty acids having a melting temperature greater than a predetermined melting temperature (e.g., greater than about 25° C.). The wax crystals may exhibit a size and/or shape prone to crystal networking exhibiting long range interactions. The wax may be a wax gel or a solid and may form a net-like or cage-like structure, preventing the flow of wetting agent. For example, depending on the composition of the wetting agent, the wetting agent may form a solid wax responsive to cooling to temperatures as high as about 0° C., as high as about 10° C., or even as high as about 25° C. Such temperatures may be referred to as a wax appearance temperature. The relatively high wax appearance temperature of the wetting agent increases the difficultly of mixing the wetting agent into a drilling fluid at a well site, such as by mixing the wetting agent into the mud pit 116. Thus, the presence of the solid wax may increase the viscosity and decrease the flowability of the wetting agent.

As described above, the wetting agent composition may further include a wax inhibitor. The wax inhibitor may be formulated and configured to reduce, substantially reduce, and/or prevent the formation of waxes that agglomerate (agglomerating wax crystals) and form gels in the wetting agent composition, such as by inhibiting the formation of long-chain wax crystals and/or long rage interactions between wax crystals in the wetting agent composition. For example, the wax inhibitor may reduce, substantially reduce, and/or prevent the formation of agglomerating wax crystals (such as long-chain hydrocarbons such as long chain aliphatic compounds) that precipitate and deposit responsive to exposure to temperatures less than about 25° C., such as less than about 20° C., less than about 10° C., or less than about 0° C. In some embodiments, the wax inhibitor substantially prevents and/or reduces the deposition of solid waxes on surfaces, such as surfaces of a container (e.g., a barrel) including the wetting agent composition. In some embodiments, the pour point of the wetting agent composition with the wax inhibitor may be lower than the pour point of the wetting agent composition without the wax inhibitor (e.g., the pour point of the wetting agent).

Without being bound by any particular theory, it is believed that the wax inhibitor disrupts the nucleation process of the wax crystals, the growth of wax crystals, and/or the agglomeration of wax crystals. The wax inhibitor may control the growth of wax crystals through one or more interactions such as nucleation, co-crystallization, adsorption, or dispersion. For example, and without being bound by any particular theory, the wax inhibitor may exhibit a higher molecular weight than the wax and may cause wax crystals to self-assemble into micelle-like aggregates to form subcritical nuclei, reducing supersaturation and prompting the formation of smaller wax crystals. The smaller wax crystals remain stable in the wetting agent composition and do not precipitate or form a solid wax structure, improving the flowability of the wetting agent composition. In some embodiments, the wax inhibitor co-crystalizes with the wax crystals, disrupting the crystallization process and modifying the growth of wax crystals. For example, the molecules of the wetting agent may adsorb on the surface of wax inhibitors having a relatively similar chemical structure, binding the wax inhibitor and the wax. The co-crystallization may alter the morphology of wax crystals and delay the formation of three-dimensional wax crystals. The co-crystallization may favor the formation of relatively smaller and substantially spherical crystals, which may exhibit improved flowability compared to flat or plate-shaped wax crystals that may form without the presence of the wax inhibitor.

Accordingly, the wax inhibitor may include one or more materials formulated and configured to inhibit the formation of wax crystals and/or to inhibit the formation of wax crystals that are prone to three-dimensional networking and long-range interactions that form a solid wax structure. In some embodiments, the wax inhibitor includes a higher molecular weight than the fatty acids of the wetting agent.

The wax inhibitor may be formulated and configured to exhibit a melting point that is substantially the same as the melting point of the fatty acids of the wetting agent. In some embodiments, the wax inhibitor exhibits a melting point that is substantially the same as the melting point of the saturated fatty acids of the wetting agent, such as of the saturated fatty acids of the wetting agent having the highest melting point. In some embodiments, the melting point of the wax inhibitor may be within a range of from about 0° C. to about 20° C. within the melting point of the saturated fatty acid(s) of the wetting agent exhibiting the highest melting point. For example, the melting point of the wax inhibitor may be within a range of from about 0° C. to about 5° C., from about 5° C. to about 10° C., from about 10° C. to about 15° C., or from about 15° C. to about 20° C. of the melting point of the saturated fatty acid of the wetting agent exhibiting the highest melting point.

The wax inhibitor may include a polymer or a copolymer (e.g., a bipolymer). The wax inhibitor may include one or more of a copolymer of a dicarboxylic acid ester and an α-olefin (a terminal alkene, a 1-alkene), olefin maleic anhydride copolymer (OMAC), a reaction product of a copolymer of the dicarboxylic acid ester and the α-olefin and one or more long-chain alcohols, a reaction product of olefin maleic anhydride copolymer and one or more long-chain alcohols, styrene maleic anhydride copolymer, a reaction product of styrene maleic anhydride copolymer and one or more long-chain alcohols, a polyalkyl acrylate, polyalkyl methacrylate (e.g., poly(methyl methacrylate) (PMMA)), ethylene vinyl acetate copolymer (EVA), a citrate crosspolymer, a polymer of methacrylic acid ester (e.g., a polymer of methacrylic acid N-hydroxysuccinimide ester), polyamidoamine, or polyethylene polyamine. In some embodiments, the wax inhibitor includes a reaction product of one or more long-chain alcohols and at least one of the copolymer of the dicarboxylic acid ester and the α-olefin, olefin maleic anhydride copolymer, or styrene maleic anhydride copolymer. In some embodiments, the wax inhibitor includes more than one type of copolymer.

In some embodiments, the wax inhibitor includes a copolymer of a dicarboxylic acid ester and an α-olefin. The dicarboxylic acid may include an ester of one or more of oxalic acid, malonic acid, succinic acid, adipic acid, azelaic acid, fumaric acid, maleic acid, muconic acid, citraconic acid, itaconic acid, tartaric acid, glutaric acid, or an ester of another dicarboxylic acid. The α-olefin may include an α-olefin of a C₅ to C₂₅ carbon chain.

The dicarboxylic acid ester may include, for example, a dialkyl maleate (e.g., dimethyl maleate, diethyl maleate, dipropyl maleate, dibutyl maleate), a dialkyl succinate (e.g., dimethyl succinate, diethyl succinate, dipropyl succinate, dibutyl succinate), a dialkyl adipate (e.g., dimethyl adipate, diethyl adipate, dipropyl adipate, dibutyl adipate), a dialkyl azelate (e.g., dimethyl azelate, diethyl azelate, dipropyl azelate, dibutyl azelate), a dialkyl fumarate (e.g., dimethyl fumarate, diethyl fumarate, dipropyl fumarate, dibutyl fumarate), or another dialkyl dicarboxylic acid ester. The alkyl groups of the dicarboxylic acid ester may be the same, or they may be different. In some embodiments, the dicarboxylic acid ester is not a dialkyl dicarboxylic acid and includes an alky dicarboxylic acid.

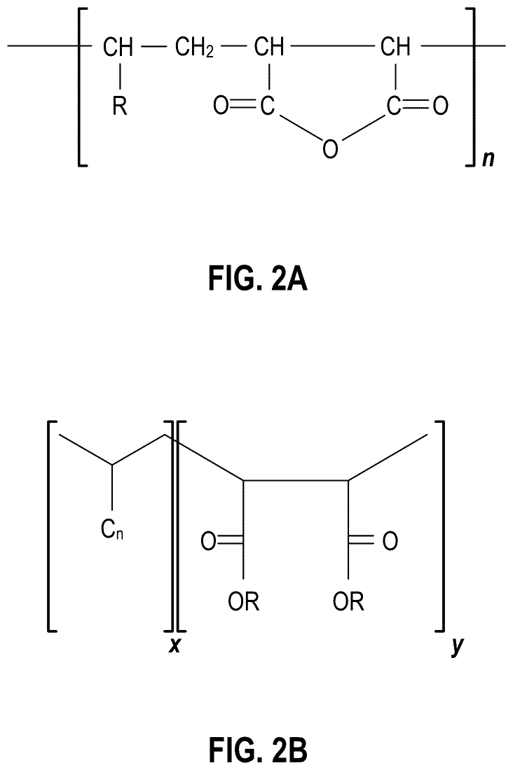

The copolymer of a dicarboxylic acid ester and an α-olefin may have the general structure shown in FIG. 2A. In some embodiments, wherein the copolymer includes a 1.0:1.0 ratio of the α-olefin to the maleic anhydride, the olefin maleic anhydride copolymer has the structure shown in FIG. 2A. The copolymer of the dicarboxylic acid and the α-olefin may be reacted with a long-chain alcohol to form a structure having the general structure shown in FIG. 2B, wherein n is within a range of from about 5 to about 25, R is hydrogen or a C₄ to C₂₅ carbon chain, x is within a range of from about 5 to about 100, and y is within a range of from about 5 to about 100. The value of R may depend on, for example, the length of the long-chain alcohol that is reacted with the copolymer of FIG. 2A. Each of x and y may individually be within a range of from about 5 to about 100, such as from about 5 to about 10, from about 10 to about 20, from about 20 to about 40, from about 40 to about 60, from about 60 to about 80, or from about 80 to about 100. In some embodiments, a ratio of x to y is about 1.0:1.0 and x and y. For example, the copolymer may include the same (e.g., substantially the same) number of monomer units of the olefin as of the dicarboxylic acid ester. In some such embodiments, the copolymer includes a same number of units of the α-olefin monomer as of the dicarboxylic acid ester. However, the disclosure is not so limited, and the values of each of x and y may be different than those described.

In some embodiments, the olefin maleic anhydride copolymer may be derivatized by at least one reaction with alcohols to form esters or alkylamines to form a maleimide. In some embodiments, the wax inhibitor includes the reaction product of an olefin maleic anhydride copolymer and one or more long-chain alcohols. In some such embodiments. In some embodiments, wherein the wax inhibitor includes a 1.0:1.0 ratio of the α-olefin to the maleic anhydride, the reaction product of the olefin maleic anhydride copolymer and the long-chain alcohol has the structure shown in FIG. 2B.

In some embodiments, the wax inhibitor includes styrene maleic anhydride copolymer and/or a reaction product of the styrene maleic anhydride copolymer with one or more long-chain alcohols. With reference to FIG. 2C, in some such embodiments, the wax inhibitor includes styrene maleic anhydride copolymer and may have the general structure illustrated in FIG. 2C. In FIG. 2C, the values of n and m may be substantially the same as the values of x and y described with reference to FIG. 2B. In some embodiments, n and m are each equal to about 1.0 and the styrene maleic anhydride copolymer includes a 1.0:1.0 ratio of the styrene monomer to the maleic anhydride monomer. In some embodiments, the styrene maleic anhydride copolymer is reacted with one or more long-chain alcohols to form the wax inhibitor, such as by opening the imidazoline ring and forming two ester groups bonded to the backbone of the copolymer, similar to the reaction product of the olefin maleic anhydride copolymer and the long-chain alcohols as described with reference to FIG. 2B. The long-chain alcohols may be C₅ to C₂₅ alcohols.

The wax inhibitor may include a poly alkyl acrylate (acrylate polymer, polyacrylate) having the general structure shown in FIG. 2D, wherein n is within a range of from 5 to 25, such as from 5 to 10, from 10 to 15, from 15 to 20, or from 20 to 25. In some embodiments, n is greater than 10, such as greater than 15, or greater than 20.

In some embodiments, the wax inhibitor includes ethylene vinyl acetate copolymer (EVA) having the generate structure shown in FIG. 2E. In FIG. 2E, n and m may be selected such that a weight percent of vinyl acetate in the ethylene vinyl acetate copolymer is within a range of from about 10.0 weight percent to about 50.0 weight percent, such as from about 10.0 weight percent to about 20.0 weight percent, from about 20.0 weight percent to about 30.0 weight percent, from about 30.0 weight percent to about 40.0 weight percent, or from about 40.0 weight percent to about 50.0 weight percent. However, the disclosure is not so limited, and the weight percent of vinyl acetate may in the ethylene vinyl acetate copolymer may be different than that described.

In some embodiments, the wax inhibitor includes a citrate crosspolymer. The citrate crosspolymer may have the general chemical structure illustrated in FIG. 2F, wherein R is an alkyl group, and X is a methylene group. The ratio of R to X may be about 1.0:1.0, greater than about 1.0:1.0, or less than about 1.0:1.0. The citrate crosspolymer may be linear or may be branched. In FIG. 2F, R may be an alkyl group having from 1 to about 50 carbon atoms, or may include hydrogen or a proton. The R group may be linear, may be branched, or may include a combination of linear and branched groups. In FIG. 2F, X may include a methylene chain terminated with one or more alcohols, such as, for example, branched diols or polyols, ethylene glycol, 1,3-propanediol, or combinations thereof.

By way of non-limiting example, the citrate crosspolymer may include one or more of poly(ethylene-co-vinyl acetate), one or more graft polymers of poly(ethylene-co-vinyl acetate), functionalized olefin maleic anhydride copolymer, functionalized styrene maleic anhydride copolymer, poly(alkylmethacrylates), one or more alkyl fumarate copolymers, one or more methacrylic/acrylic copolymers, one or more vinyl acetate olefin copolymers, one or more alkyl phenol resin copolymers, one or more hyperbranched or dendrimeric copolymers, and a mixture thereof. In some embodiments, the citrate crosspolymer includes one or more of octyldodecyl citrate crosspolymer, stearyl/octyldodecyl citrate crosspolymer, behenyl/octyldodecyl propanediol citrate crosspolymer, and a mixture thereof.

The citrate crosspolymer may be derived from, for example, citric acid, one or more alcohols having one or more different chain lengths, and at least one crosslinking agent. The one or more different chain lengths of the one or more alcohols may be from C₈ to C₃₀, such as from C₈ to C₁₀, from C₁₀ to C₁₅, from C₁₅ to C₂₀, from C₂₀ to C₂₅, or from C₂₅ to C₃₀. In some embodiments, the alcohol includes stearyl alcohol, octyldodecyl alcohol, behenyl alcohol, or combinations thereof.

The wax inhibitor may be present in the wetting agent composition within a range of from about 0.10 weight percent to about 1.00 weight percent, such as from about 0.10 weight percent to about 0.20 weight percent, from about 0.20 weight percent to about 0.40 weight percent, from about 0.40 weight percent to about 0.60 weight percent, from about 0.60 weight percent to about 0.80 weight percent, or from about 0.80 weight percent to about 1.00 weight percent. In some embodiments, the wax inhibitor is present in the wetting agent composition at least than about 1.00 weight percent, such as less than about 0.80 weight percent, less than about 0.60 weight percent, or less than about 0.50 weight percent. In some embodiments, the wax inhibitor constitutes greater than about 0.10 weight percent of the wetting agent composition. In some embodiments, a remaining portion of the wetting agent composition is the wetting agent.

A pour point of the wetting agent composition may be less than about 0° C., such as less than about −5° C., less than about −10° C., less than about −15° C., less than about −20° C., or less than about −25° C. Thus, the wetting agent composition may exhibit suitable rheological properties at temperatures as low as about 0° C., such as lower than about −5° C., lower than about −10° C., or lower than about −20° C., facilitating the provision of the wetting agent composition in drilling fluids at a well site (e.g., at the mud pit 116) at conditions to which the mud pit 116 and the well site are exposed.

In some embodiments, the wetting agent composition comprises, consists essentially of, or consists of the wetting agent and the wax inhibitor. In some embodiments, the wetting agent composition does not include a solvent or a pour point depressant. In some embodiments, the wetting agent composition comprises a flowable composition consisting essentially of or consisting of one or more fatty acids and a wax inhibitor. In some embodiments, the wetting agent composition further includes a base oil (e.g., a solvent) formulated and configured to further reduce the pour point of the wetting agent composition. The base oil, in combination with the wax inhibitor, may exhibit synergistic properties and may reduce the pour point of the wetting agent composition. The base oil may include diesel oil, mineral oil, a synthetic oil, (e.g., hydrogenated and unhydrogenated olefins including polyalpha olefins, linear and branched olefins, isomerized olefins), a mixture of alkanes with a carbon chain length ranging from C₁₀ to C₂₀, polydiorganosiloxanes, siloxanes, organosiloxanes, or esters of fatty acids, a mixture of C₁₆ to C₁₈ internal olefins.

In some embodiments, a relatively low weight percent of the wax inhibitor is sufficient to inhibit agglomeration and precipitation of wax crystals in the wetting agent composition and to maintain suitable rheological properties of the wetting agent for providing the wetting agent composition from a drum or barrel to a drilling fluid. For example, the wetting agent composition may be flowed from a container (e.g., a drum, a barrel) to the mud pit 116 to deliver the wetting agent composition to the drilling fluid. The wax inhibitor facilitates the formation of a wetting agent composition having a relatively low pour point such that the wetting agent composition may be flowed at the well site at temperatures as low as about −25° C. or less and without a solvent or a glycol-based pour point depressant. Since the wetting agent composition does not include a solvent or a glycol-based pour point depressant, and includes less than about 1.00 weight percent of the wax inhibitor, the wetting agent composition may include a higher amount of active ingredient (e.g., the wetting agent) than wetting agent compositions that require a solvent and/or a glycol-based pour point depressant.

As described above, the drilling fluid may include one or more additives, which may be selected based on the desired properties of the drilling fluid. By way of non-limiting example, the one or more additives may include one or more of emulsifiers, surfactants, bridging materials, viscosifiers, wetting agents, thinners, weighting materials, filtration control agents, shale stabilizers, pH buffers, scavengers, emulsion activators, gelling agents, shale inhibitors, defoamers, foaming agents, scale inhibitors, solvents, rheological additives, or other additives that may be suitable depending on the particular operation.

The emulsifiers may include fatty acid esters, bis-amides (e.g., reaction products of a bis-amide and a dicarboxylic acid, such as maleic acid, fumaric acid, or succinic acid), calcium polyvalent metal soaps, phosphate esters, fatty acid soaps, alkylbenzene sulfonate, lime, amidoamines, and imidazolines. In some embodiments, the drilling fluid includes the base fluid, the wetting agent composition, and an emulsifier. It is believed that the wetting agent composition and the emulsifier exhibit synergistic properties to improve the stability of the emulsion and reduce fluid loss of the drilling fluid to the earth formation 101.

The surfactants may include anionic surfactants, cationic surfactants, and/or non-ionic surfactants. The foaming agents may include a nonionic surfactant including polymeric materials. The scale inhibitors may include an acrylic acid polymer, a maleic acid polymer, or a phosphonate. The solvents may include hydrocarbon solvents.

The bridging materials may include one or more of calcium carbonate, magnesium citrate, calcium citrate, calcium succinate, calcium maleate, calcium tartrate, magnesium tartrate, bismuth citrate, other suspended salts, mica, nutshells, fibers, or other building materials. In some embodiments, the building materials comprise calcium carbonate. The bridging material may be functionalized with one or more functional groups, such as one or more hydrophobic functional groups.

Viscosifiers of the drilling fluid may include a material formulated and configured to increase the viscosity of the wellbore fluid and, optionally, to facilitate formation of a filtercake between the earth formation 101 and one or more of (e.g., each of) the drill string 105, casing 107, and liners. The viscosifier may include, for example, organic bentonite clay, an organic polymer (e.g., a cellulosic polymer), a polymer (e.g., a copolymer) formed from at least one acrylamide monomer and at least one sulfonated anionic monomer, or another polymer.

The viscosifier may constitute from about 0.5 weight percent to about 6.0 weight percent of the wellbore fluid, such as from about 0.5 weight percent to about 1.0 weight percent, from about 1.0 weight percent to about 2.0 weight percent, from about 2.0 weight percent to about 3.0 weight percent, or from about 3.0 weight percent to about 6.0 weight percent of the wellbore fluid. However, the disclosure is not so limited, and the weight percent of the viscosifier in the wellbore fluid may be different than that described.

Wellbore fluid thinners may include lignosulfates, lignitic materials, modified lignosulfonates, polyphosphates, tannin, and polyacrylates. The thinners may facilitate improved rheological properties of the wellbore fluid (e.g., a reduction in flow resistance) and a reduction in gel development. In addition, the thinner may reduce a thickness of filtercakes formed by the wellbore fluid, counteract the effects of salts, and reduce the effects of water on the earth formation 101.

Weighting materials (also referred to as “weighting agents”) may include one or more of barite (BaSO₄), iron oxide (e.g., Fe₂O₃, Fe₃O₄), calcium carbonate (CaCO₃), magnesium carbonate (MgCO₃), manganese oxide (Mn₃O₄), or combinations thereof. The weighting material may be present in the wellbore fluid and facilitate increasing the density of the wellbore fluid up to about 2.88 g/cm³ (about 24 pounds per gallon (ppg)).

The pH buffer may include an amine stabilizer, such as one or more of triethanolamine (C₆H₁₅NO₃) (TEOA), methyldiethanolamine (C₅H₁₃NO₂) (MDEA), dimethylethanolamine (C₄H₁₁NO) (DMEA), diethanolamine (C₄H₁₁NO₂) (DEA), monoethanolamine (MEA), cyclic organic amines, sterically hindered amines, amides of fatty acid, or other suitable tertiary, secondary, or primary amines and ammonia. In some embodiments, the pH buffer includes magnesium oxide.

Wetting agents may include one or more alkanolamines, imidazolines, or amidoamines. Filtration control agents may include one or more of uintaite, amine-treated lignite, a polymeric additive, or another material. Shale stabilizers may include organophilic clays, cellulose derivates, or other materials. The scavenger may include, for example, zinc oxide, which may function as a hydrogen sulfide (H₂S) scavenger).

The gelling agent may include one or more of a clay and a crosslinked polyvinylpyrrolidone, an acrylamide copolymer, guar, sodium bentonite, or another material. Defoamers may include one or more of 2-octanol, oleic acid, paraffinic waxes, amide waxes, sulfonated oils, organic phosphates, silicone oils, mineral oils, or dimethylpolysiloxane.

The shale inhibitor may include one or more of amine tartaric salt, ammonium lauric salt, polyammonium, alkyl diammonium, an amphoteric polymer, an organosilicate polymer, a silicone polymer, hexamethylenediamine, bis-hexamethylene triamine, diaminocyclohexane, or another material. In some embodiments, the shale inhibitor includes an amine-based shale inhibitor.

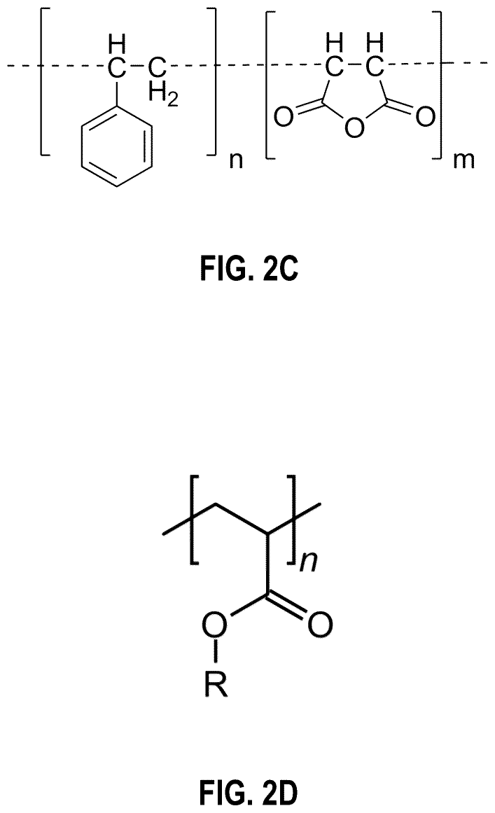

FIG. 3 is a simplified flow diagram illustrating a method of drilling a borehole, according to at least one embodiment of the disclosure. The method 300 includes mixing a wetting agent composition with a drilling fluid to form a drilling fluid including the wetting agent composition, as shown at act 302. In some embodiments, the wetting agent composition is mixed with the drilling fluid at a mud pit. The drilling fluid may include one or more of the drilling fluids described above. For example, the drilling fluid may include, a base fluid, the wetting agent composition, and one or more additives, as described above.

The wetting agent composition may include one or more of the wetting agent compositions including one or more of the wetting agents and one or more of the wax inhibitors described above. The wetting agent composition may be substantially free of solvents and glycol-based pour point depressants. In some embodiments, the wetting agent composition includes greater than about 99.0 weight percent fatty acids. In some embodiments, act 302 includes flowing a liquid wetting agent composition into the drilling fluid, such as from a drum or barrel.

Responsive to forming the drilling fluid including the wetting agent composition, the method 300 further includes pumping the drilling fluid including the wetting agent composition into an earth formation, as shown at act 304. With continued reference to FIG. 3, the method 300 may include drilling the earth formation while pumping the drilling fluid including the wetting agent composition into the earth formation to form a borehole, as shown at act 306. The drilling fluid may facilitate removal of cuttings from the borehole as the drilling fluid circulates through the borehole.

The method 300 may further include circulating the drilling fluid including the wetting agent composition within the borehole, as shown in act 308. For example, the drilling fluid may be pumped from the surface of the earth formation, through the drill string 105, out of the bit 110, and through the annulus between the drill string 105 and the earth formation 101. In some embodiments, the drilling fluid is circulated within the borehole while drilling the earth formation. In some embodiments, the wetting agent facilitates wetting the cuttings and/or surfaces of the earth formation while drilling the borehole.

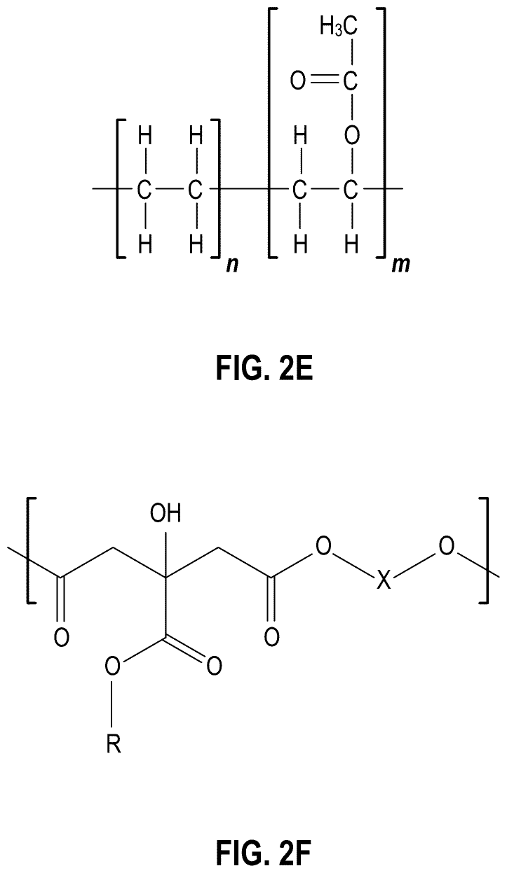

In some embodiments, a wetting agent composition can be prepared from vegetable oils including saturated fatty acids (or vegetable oils including saturated fatty acid esters from which the saturated fatty acids are derived). FIG. 4 is a simplified flow diagram illustrating a method 400 of dewaxing a mixture of fatty acids including at least some saturated fatty acids. The method 400 includes mixing a wax inhibitor with a mixture of fatty acids including at least some saturated fatty acids, as shown in act 402. The mixture of fatty acids may be derived from one or more vegetable oils, such as by hydrolysis of one or more vegetable oils. In some embodiments, the mixture of fatty acids may be heated when mixed with the wax inhibitor. The at least some saturated fatty acids may include one or more types of saturated fatty acids, such as one or more of C₁₆ or C₁₈ saturated fatty acids. By way of non-limiting example, the saturated fatty acids may include palmitic acid and stearic acid.

The method 400 may include cooling the mixture of fatty acids, as shown in act 404. In some embodiments, the mixture of the fatty acids is cooled to a temperature of about 0° C. The mixture of fatty acids may be cooled to a temperature less than about 0° C., such as less than about −5° C., less than about −10° C., less than about −15° C., less than about −20° C., or less than about −25° C.

Responsive to cooling the mixture of fatty acids, the method 400 may further include centrifugating the mixture of fatty acids to remove the saturated fatty acids from the mixture of fatty acids, as shown in act 406. For example, the saturated fatty acids and the wax inhibitor may co-crystallize and form small solid crystals in the mixture of fatty acids. Centrifugation may separate the solid wax crystals from the remaining fatty acids in the mixture. In some embodiments, the solid wax crystals are removed from the mixture of fatty acids, leaving substantially only unsaturated fatty acids in the mixture.

Without the wax inhibitor, the mixture of fatty acids may solidify, preventing the removal of the saturated fatty acids from the mixture of fatty acids. Removing the saturated fatty acids facilitates forming a mixture of fatty acids that is substantially free of saturated fatty acids and exhibits a pour point that is lower than the pour point of the original fatty acid mixture including saturated fatty acids. Thus, in some embodiments, a fatty acid mixture substantially free of saturated fatty acids may be prepared from vegetable oils that include saturated fatty acids and/or saturated fatty acid esters.

### EXAMPLES

### Example 1

The performance of various fatty acids as wetting agents were tested by mixing different wetting agents with a drilling fluid composition. The drilling fluid composition is shown in Table 1 below.

TABLE 1

| Material | Mass (pounds per barrel) (ppb) |
|---|---|
| High temperature viscosifier | 6.00 |
| Oleaginous base fluid | 139 |
| Emulsifier | 8.00 |
| Asphalt filtration control additive | 6.00 |
| Lime | 5.00 |
| 25% CaCl₂ brine | 46.0 |
| Rheology modifier 1 | 2.00 |
| Rheology modifier 2 | 1.20 |
| Barite | 458 |
| Wetting agent | 2.00 |

In Table 1, the drilling fluid composition exhibited a density of about 15.95 pounds per gallon (ppg) and a synthetic fluid to water ratio (SWR) of about 85.1%. The synthetic fluid to water ratio is defined as the volume percent of the synthetic fluid in the composition to the volume percent of the water in the composition (e.g., volume percent synthetic fluid/volume percent water) after retort distillation (and collecting all non-aqueous volatile species and water, but not salts). Each drilling fluid composition (other than the drilling fluid composition that included wetting agent 4 as described below) included about 2.00 ppb of a particular wetting agent. The wetting agents tested included wetting agent 1 including a wetting agent with a high oleic acid content; a wetting agent 2 including linoleic acid; wetting agent 3 including a wetting agent sourced from distilled tall oil having a mixture including 70 volume percent oleic acid and linoleic acid and 30 volume percent rosin; wetting agent 4 including wetting agent 3 but at a 30 percent higher concentration than wetting agent 3 (i.e., wetting agent 4 had 2.60 ppb of the wetting agent while wetting agent 3 had 2.00 ppb of the wetting agent); and wetting agent 5 including rosin. Since wetting agent 3 included 30 volume percent rosin, wetting agent 3 included about 30 volume percent less active component of wetting agent; and wetting agent 4 included about the same volume percent of active wetting agent as wetting agents 1 and 2.

The properties of the drilling fluids including the different wetting agents were measured and compared to one another. Each drilling fluid was hot rolled at about 204.4° C. (about 400° F.) for about 16 hours and the shear stress of the drilling fluids was measured using a rotational couette viscometer at different rotation speeds. In addition, the gel strength and the fluid loss of the drilling fluids when exposed to HPHT testing at a differential pressure at about 176.7° C. (about 350° F.) were also tested.

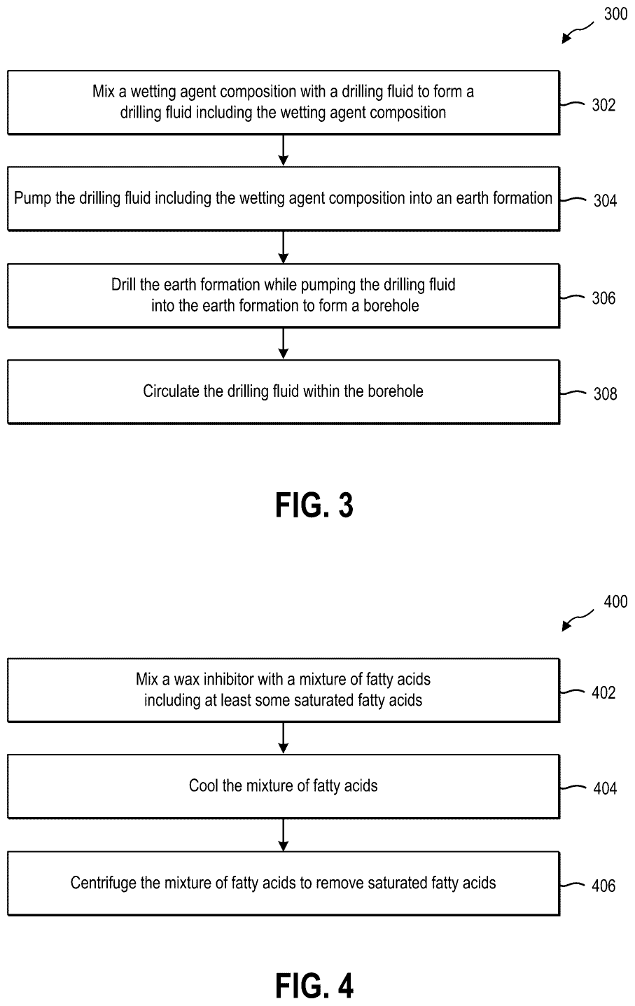

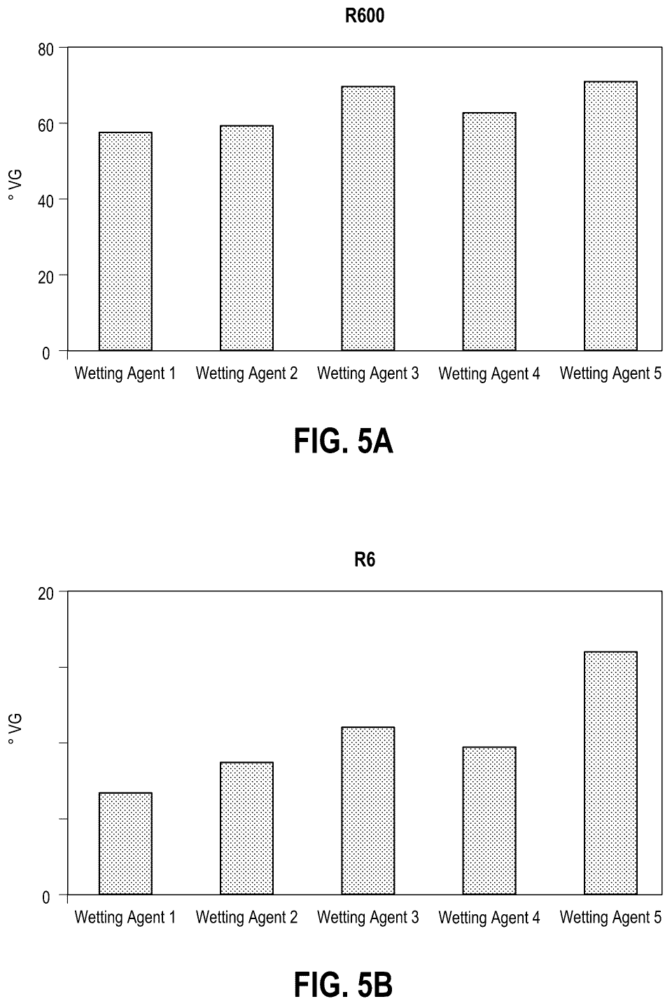

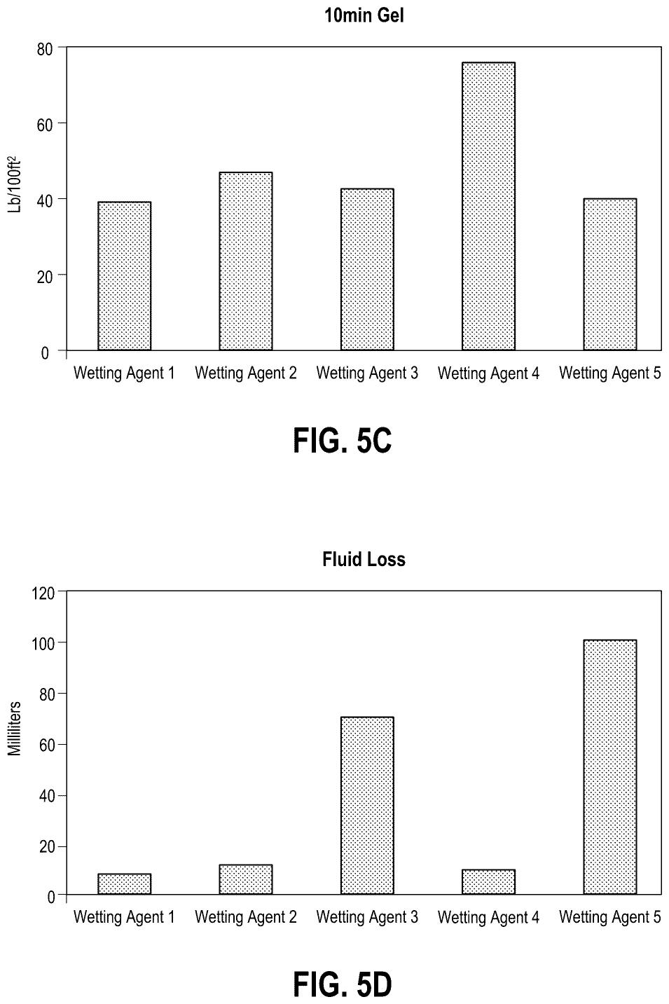

FIG. 5A and FIG. 5B are graphs comparing R600 and the R6 Fann shear stress, respectively, of the drilling fluids having the different wetting agents. With collective reference to FIG. 5A and FIG. 5B, at the R600, the drilling fluids including each of the wetting agents exhibited similar gel strength. With reference to FIG. 5B, the drilling fluid including wetting agent 1 including the high amount of oleic acid and the drilling fluid including wetting agent 2 including linoleic acid exhibited better (lower gel strength) than the drilling fluids including wetting agents 3, 4, and 5 including distilled tall oil or rosin.

FIG. 5C is a graph illustrating the 10-minute gel strength of the different drilling fluids. With reference to FIG. 5C, the drilling fluid including wetting agent 4 exhibited the highest gel strength after 10 minutes. The other drilling fluids exhibited relatively similar gel strength after 10 minutes. FIG. 5D is a graph illustrating the fluid loss exhibited by the different drilling fluids. With reference to FIG. 5D, the drilling fluids including the oleic acid wetting agent 1, the linoleic acid wetting agent 2, or the distilled tall oil wetting agent 4 exhibited significantly lower fluid loss than the drilling fluids including a lower dose of the distilled tall oil wetting agent 3 or the rosin wetting agent 5. It appears that the concentration of the wetting agent affects the fluid loss and the gel strength of the drilling fluids, while the ratio of oleic acid to linoleic acid affects the fluid loss less than the concentration of the wetting agent. Wetting agents 1, 2 and 4 appeared to exhibit about the same amount of fluid loss. Each of wetting agents 1, 2, and 4 included about the same amount of active component of the wetting agent, whereas wetting agent 3 included a lower amount of active components of the wetting agent. Wetting agent 5 included rosin and indicates that rosin is an ineffective wetting agent (and showing that the effective wetting agents of the tested wetting agent compositions included oleic acid and linoleic acid). As can be seen, dilution of the active components of the wetting agent (such as with a glycol-based pour point depressant or a base oil) may reduce the effectiveness of the same volume of wetting agent. The wax inhibitor may reduce the pour point while occupying a substantially smaller volume percent of the wetting agent composition than glycol-based pour point depressants and/or base oils.

### Example 2

The properties of drilling fluid compositions including different wax inhibitors were tested to determine whether the presence of the wax inhibitors in the drilling fluid compositions affected the performance of the drilling fluids, such as the emulsion stability or the rheology of the drilling fluids. The drilling fluids included the same composition as the drilling fluids of Example 1 and the drilling fluids that included a wetting agent included 2.0 ppb of the wetting agent. Drilling fluid 1 included an oleic acid wetting agent and no wax inhibitor; drilling fluid 2 included a wetting agent including about 7.0 weight percent palmitic acid, about 3.0 weight percent stearic acid, about 44.0 weight percent oleic acid, about 40.0 weight percent linolic acid, and about 6.0 weight percent linolenic acid and did not include a wax inhibitor; drilling fluid 3 included the same wetting agent as drilling fluid 2, but the wetting agent included 1.0 weight percent of an olefin-maleic anhydride copolymer wax inhibitor; drilling fluid 4 included the same wetting agent as drilling fluid 2, but the wetting agent included about 1.0 weight percent of an ethylene vinyl acetate copolymer wax inhibitor; and drilling fluid 5 did not include any wetting agent. The results are shown in Table 2 below.

TABLE 2

| | Drilling | Drilling | Drilling | Drilling | Drilling |
|---|---|---|---|---|---|
| | Fluid 1 | Fluid 2 | Fluid 3 | Fluid 4 | Fluid 5 |
| Rheology temp, ° F. | 150 | 150 | 150 | 150 | 150 |
| R600, °VG | 116 | 117 | 124 | 133 | 158 |
| R300, °VG | 71.1 | 66.7 | 73.3 | 82.6 | 93.8 |
| R200, °VG | 51.3 | 48.5 | 54.1 | 59.8 | 68.3 |
| R100, °VG | 29.4 | 28.6 | 31.7 | 34.8 | 39.4 |
| R6, °VG | 7.4 | 7.6 | 8.5 | 10.5 | 17.2 |
| R3, °VG | 6.8 | 7.2 | 7.7 | 10.3 | 17.7 |
| Plastic viscosity, cp | 45 | 50 | 50 | 51 | 64 |
| Yield point, lb/100 ft² | 26 | 17 | 23 | 32 | 30 |
| LSYP, lb/100 ft² | 6 | 7 | 7 | 10 | 18 |
| 10-sec gel, lb/100 ft² | 10.8 | 11.7 | 11.3 | 13.9 | 27.2 |
| 10-min gel, lb/100 ft² | 22.1 | 33.9 | 32.5 | 40.5 | 50.3 |
| HTHP Temp, | 350 | 350 | 350 | 350 | 350 |
| HTHP FL, ml | 5.2 | 4 | 5.2 | 5.2 | 62 |
| Water in HTHP filtrate, | 0 | 0 | 0 | 0 | 0 |
| ml | | | | | |

With reference to Table 2, the drilling fluids including the wax inhibitors in the wetting agent exhibited suitable rheological properties and exhibited a stable emulsion, as shown in the low fluid loss. The fluid loss of the drilling fluids including the wax inhibitors in the wetting agents was similar to the fluid loss of the drilling fluids not including the wax inhibitors in the wetting agents. Thus, the wax inhibitors may be used in drilling fluid compositions without negatively affecting (e.g., without substantially negatively affecting) the stability of emulsions and/or the rheological properties of the drilling fluid compositions.

### Example 3

The effectiveness of different wax inhibitors at inhibiting the formation of solid waxes was tested. A fatty acid mixture including about 7.0 weight percent palmitic acid, about 3.0 weight percent stearic acid, about 44.0 weight percent oleic acid, about 40.0 weight percent linoleic acid, and about 6.0 weight percent linolenic acid was prepared. The fatty acid mixture included about 10.0 weight percent of saturated fatty acids (the palmitic acid and the stearic acid). The pour point of the fatty acid mixture was between about 10° C. and about 13° C. The fatty acid mixture was treated with 0.5 weight percent of different wax inhibitors to test the effectiveness of the different wax inhibitors at reducing the pour point and reducing or preventing the formation of large wax crystals that solidify the fatty acid mixture. After adding the wax inhibitor, each fatty acid mixture with the different wax inhibitors was stored in an ice bath and the flowability at 0° C. was measured. The results are shown in Table 3 below. The HITEC® wax inhibitors were commercially available from Afton Chemical of Richmond, Virginia; the FLowSolve™ wax inhibitor was commercially available from Cargill, Incorporated of Wayzata, Minnesota; and the Dodiflow was commercially available from Clariant of Muttenz, Switzerland.

TABLE 3

| Wax Inhibitor | Result |
|---|---|
| HITEC ® 5714 Polymethacrylate | Flows |
| HITEC ® 672 Styrene/maleic ester | Flows with some limited settling |
| HITEC ® 5788 Polymethacrylate | Flows |
| HITEC ® 18933DN alkenylacetate | Hard settling but partially liquid |
| olefin copolymer | |
| HITEC ® 18536x alkenylacetate | High amount of precipitates (likely |
| olefin copolymer | greater than 60%) |
| HITEC ® 4569 alkenylacetate | Hard settling, but amount of wax |
| olefin copolymer | was low |
| Flowsolve 430-LQ α-olefin maleic | No settling, poured easily |
| anhydride copolymer | |
| Dodiflow 5723-1C, ethylene vinyl | Slightly more viscous than |
| acetate copolymer | Flowsolve sample, but no settling |
| | and was poured easily |

With reference to Table 3, the polymethacrylate-based, the styrene/maleic ester-based, and the α-olefin maleic anhydride copolymer wax inhibitors exhibited good flow properties at 0° C. and did not exhibit settling.

The embodiments of wellbore (e.g., drilling) fluids including the wetting agent composition including the wax inhibitor have been primarily described with reference to wellbore drilling operations; the drilling fluids described herein may be used in applications other than the drilling of a wellbore or borehole. In other embodiments, wellbore fluids including the wetting agent composition according to the present disclosure may be used outside a wellbore, borehole, or other downhole environment used for the exploration or production of natural resources. Accordingly, the terms “wellbore,” “borehole,” and the like should not be interpreted to limit tools, systems, assemblies, or methods of the present disclosure to any particular industry, field, or environment. In addition, the drilling fluids may be used in cased completion wellbores and in open hole completion wellbores.

In some embodiments, the drilling fluids may be used during formation of a borehole and/or wellbore to be used for carbon capture, utilization, and storage (CCUS) and/or for recovery and use of geothermal energy. For example, the drilling fluids may be used to form boreholes and/or wellbores without introducing materials to the earth formation that may impede subsequent storage of carbon in the earth formation.

Geothermal energy is a promising source of renewable energy that captures energy from heat generated within the earth. For example, geothermal energy may be used to heat structures (e.g., buildings) and/or to generate electricity (e.g., by heating water to generate steam and drive a turbine with the steam). The drilling fluids described herein may be used to form boreholes and/or wellbores used to circulate a fluid that is heated within the earth formation through which the borehole and/or wellbore extends. The heated fluid may be circulated to the surface where the captured heat may be recovered to heat a structure and/or generate electricity, followed by recirculation of the fluid to the earth formation to continue the cycle.

CCUS facilitates the capture, use, and/or storage of carbon (e.g., carbon dioxide), which has a goal of achieving carbon neutrality and/or net zero carbon emissions (NZE). CCUS may facilitate the capture of carbon dioxide from large point sources (e.g., power plants, refineries, cement plants, other industrial processing plants, or other industrial facilities that use fossil fuels, biomass fuels, or other fuels that generate carbon dioxide). The captured carbon dioxide may be converted into valuable products such as, for example, ethanol, sustainable aviation fuel, chemicals, and mineral aggregates. Alternatively, the carbon dioxide may be stored in geologic formations, such as in depleted hydrocarbon reservoirs. The carbon dioxide may be introduced into the earth formation through a borehole and/or wellbore formed using the drilling fluids described herein. In the earth formation, the carbon dioxide may be dispersed in an aqueous phase and stored as carbon dioxide, in mineral form (e.g., as a carbonate, such as calcium carbonate, magnesium carbonate, iron(II) carbonate), or as another form of carbon.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A wetting agent composition for a drilling fluid, the wetting agent composition comprising:
a wetting agent including unsaturated fatty acids and at least some saturated fatty acids; and
a wax inhibitor formulated and configured to inhibit the formation of wax crystals that agglomerate and gel in the wetting agent composition,
wherein the wetting agent composition exhibits a pour point lower than about 0° C.

2. The wetting agent composition of claim 1, wherein wetting agent constitutes greater than about 99.0 weight percent of the wetting agent composition.

3. The wetting agent composition of claim 1, wherein the wetting agent includes greater than about 2.0 weight percent of linear saturated fatty acids.

4. The wetting agent composition of claim 1, wherein the wetting agent includes C₁₈ fatty acids.

5. The wetting agent composition of claim 1, wherein the unsaturated fatty acids include oleic acid, linoleic acid, and linolenic acid.

6. The wetting agent composition of claim 1, wherein the saturated fatty acids include at least one of palmitic acid or stearic acid.

7. The wetting agent composition of claim 1, wherein the wax inhibitor includes one or more of a copolymer of a dicarboxylic acid ester and an α-olefin, olefin maleic anhydride copolymer, styrene maleic anhydride copolymer, a polyalkyl acrylate, polyalkyl methacrylate, ethylene vinyl acetate copolymer, or a citrate crosspolymer, or a reaction product of one or more long-chain alcohols and at least one of the copolymer of the dicarboxylic acid ester and the α-olefin, olefin maleic anhydride copolymer, or styrene maleic anhydride copolymer.

8. The wetting agent composition of claim 1, wherein the wax inhibitor includes a reaction product of the one or more long-chain alcohols and the copolymer of the dicarboxylic acid ester and the α-olefin.

9. The wetting agent composition of claim 1, wherein the wetting agent includes a reaction product of olefin maleic anhydride copolymer and the one or more long-chain alcohols.

10. The wetting agent composition of claim 1, wherein the wax inhibitor exhibits the structure below, 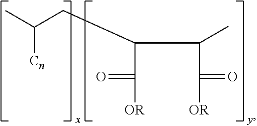
wherein n is from 5 to 25, and R is hydrogen or includes between 20 carbon atoms to 24 carbon atoms.

11. The wetting agent composition of claim 1, wherein the wax inhibitor is present in the wetting agent composition at less than about 1.0 weight percent.

12. The wetting agent composition of claim 1, wherein the wax inhibitor exhibits a melting point within a range of from about 0° C. to about 20° C. of a melting point of the saturated fatty acids.

13. The wetting agent composition of claim 1, wherein the wetting agent composition consists essentially of the wetting agent and the wax inhibitor.

14. The wetting agent composition of claim 1, wherein the wetting agent composition further comprises a solvent including a base oil.

15. The wetting agent composition of claim 1, wherein the wetting agent composition exhibits an iodine value greater than about 110.

16. A method of forming a borehole extending through an earth formation, the method comprising:
mixing a wetting agent composition with a drilling fluid, the wetting agent composition including:
a wetting agent including unsaturated fatty acids and at least some saturated fatty acids; and
a wax inhibitor; and
forming a borehole in the earth formation while pumping the drilling fluid including the wetting agent composition into the earth formation.

17. The method of claim 16, wherein mixing a wetting agent composition with a drilling fluid includes mixing a wetting agent composition including greater than about 99.0 weight percent of the wetting agent and less than about 1.0 weight percent of the wax inhibitor with the drilling fluid.

18. The method of claim 16, wherein mixing a wetting agent composition including a wetting agent comprising greater than 10.0 weight percent of the at least some saturated fats with the drilling fluid.

19. The method of claim 16, wherein mixing a wetting agent composition with a drilling fluid includes flowing the wetting agent composition from a drum or barrel into a mud pit to mix the wetting agent composition with the drilling fluid.

20. A drilling fluid, comprising:
an oleaginous base fluid;
a wetting agent composition comprising:
a wetting agent including greater than about 2.0 weight percent saturated fatty acids sourced from vegetable oils or animal sources; and
a wax inhibitor; and
an emulsifier.
